(19) United States
(12) Patent Application Publication
(10) Pub. No.: US 2012/0290375 A1
(43) Pub. Date: Nov. 15, 2012

(54) Multi-Consumer Classification and Automated Rewards-Based System

(76) Inventors: Phuc Truong, Boston, MA (US); John Moran, N. Reading, MA (US)

(21) Appl. No.: 13/447,029

(22) Filed: Apr. 13, 2012

Related U.S. Application Data
(60) Provisional application No. 61/485,515, filed on May 12, 2011.

(51) Int. Cl. G06Q 30/02

(52) U.S. Cl. 705/14.17; 705/14.27

(57) ABSTRACT

Approaches for reward based system for multiple consumers organized as a group. Group data and incentive data are stored. Group data identifies a group of users that have entered into an agreement to negotiate, as a single entity, with a seller for terms of a loyalty rewards program. Incentive data identifies a negotiated loyalty rewards program between the group and the seller. User profile data that identifies that the payment instrument is associated with the particular user may also be stored. Upon receiving payment data from a payment processor associated with a payment instrument of a particular user of the group, whether the particular user is entitled to receive a particular reward based upon (a) a purchase of the particular user identified in the payment data and (b) the negotiated loyalty rewards program is determined. The payment instrument may be credited with a monetary sum corresponding to the particular reward.

### CLAIM OF PRIORITY

This application claims priority to U.S. provisional patent application No. 61/485,515, filed on May 12, 2011, invented by Phuc Truong et al., entitled “Multi-Consumer Classifications and Automated Rewards-Based System,” the contents of which are hereby incorporated by reference for all purposes as if fully set forth herein.

### FIELD OF THE INVENTION

Embodiments of the invention generally relate to a reward based system for multiple consumers organized as a group.

### BACKGROUND

In order to encourage consumers to purchase their products or services, many merchants offer discounts to consumers over the Internet. For example, certain merchants may offer a “deal-of-the-day,” which is an offer of a limited duration for a discount on a particular product or service, over an online forum.

Groupon is a public company that provides a web site of the same name that offers many “deals-of-the-day” for merchants. The Groupon web site displays a variety of different discounts on products and services available to consumers of a particular geographical region.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 is a block diagram of an illustrative system according to an embodiment of the invention;

FIG. 2 is a flowchart illustrating the functional steps of an exemplary use case involving an embodiment of the invention;

FIG. 3 is a graphical illustration of an exemplary process flow according to an embodiment of the invention;

FIG. 4 is a block diagram that illustrates a computer system upon which an embodiment of the invention may be implemented; and

FIG. 5 is another graphical example of the above exemplary process flow according to an embodiment of the invention.

### DETAILED DESCRIPTION OF THE INVENTION

Approaches for a reward based system for multiple consumers organized as a group are presented herein. In the following description, for the purposes of explanation, numerous specific details are set forth in order to provide a thorough understanding of the embodiments of the invention described herein. It will be apparent, however, that the embodiments of the invention described herein may be practiced without these specific details. In other instances, well-known structures and devices are shown in block diagram form or discussed at a high level in order to avoid unnecessarily obscuring teachings of embodiments of the invention.

### Functional Overview

Embodiments of the invention are directed towards a platform (entitled the “Crowdperks platform” or simply “Crowdperks (CP)”) that allows one or more consumers to organize as a group in order to create and cultivate incentive-based relationships between the group and one or more business entities, such as a manufacturer, a merchant, or a service provider. Advantageously, embodiments enable business entities (herein “sellers”) to custom tailor rewards-based programs for multiple consumers organized as a group based on the seller's business judgment and/or the business economics for the seller without the need for the seller to issue any loyalty card or tokens associated with an offer.

After the group of consumers has negotiated a rewards program with a seller, each time a member of the group conducts a certain amount of business with the seller, that member may be eligible for a certain negotiated reward, such as a discount or credit, if the member meets a spending milestone specified by the rewards program. In an embodiment, a group may have a limited period of time to conduct negotiations with a seller. Thus, negotiations with a group and seller may need to occur with a bounded period of time. Note that the length of the window of time in which negotiations are to be conducted and concluded may be configurable and may vary based on the particular seller and/or the particular group.

In an embodiment, instead of relying upon the use of loyalty cards or tokens, the mechanism used to track a consumer's activity (such as a purchase) is the consumer's payment instrument, such as a credit card, a debit card, or a prepaid card, for example. To facilitate tracking of the consumer's activity, the consumer registers his or her payment instrument with the Crowdperks platform. This may be done by registering the payment instrument with a Crowdperks server via a web page, a mobile device, or other such electronic mechanism. After the consumer uses a registered payment instrument in a business transaction, the Crowdperks platform will be notified of the purchase. One way in which the Crowdperks platform may be notified is by the Crowdperks platform receiving information (such as a payment data feed) sent from a payment processor associated with the consumer's payment instrument.

Once information about the business transaction is received, the Crowdperks platform may identify and catalog the business transaction against a profile for the consumer and a profile for the group. The Crowdperks platform may subsequently issue credits to the purchasing consumer (for example, by applying a credit to consumer's payment instrument) if certain reward milestones for a group associated with the consumer have been achieved.

In some embodiments, consumers that are registered with the Crowdperks platform may be rated based on their individual spending history. This rating may be referred to as a Crowdperks score (abbreviated as a “CP score”). Certain groups may require a minimum CP score to join and/or maintain membership in the group. A consumer's CP score may serve the role as a “credit score,” and may be used in a variety of different ways. For example, in certain embodiments, a higher cumulative, average, or median CP score of members of a group may consequently provide the group with greater negotiating power with sellers to obtain favorable terms in a negotiated rewards program between the seller and the group, since the better CP score would indicate that the group will conduct more business with the seller, thereby inducing the seller to seek an agreement with the group.

In an embodiment, a CP score for an individual may also consider and/or be based, at least in part, upon the user's record with sharing aspects of the Crowdperks platform with members of their social graph. For example, a user's CP score may be raised if the user shares postings about deals and other information about the Crowdperks platform with the user's friends using social media sites or other such mechanisms. The CP score may also be used as a basis for recruiting highly rated users during an open enrollment period for a group. It would be advantages for a group to include high rated users in order to strengthen the overall group score for that group. Conversely, in certain embodiments, groups may also dismiss non-performing consumers whose lack of spending negatively affects the respective group score for that group.

### Advantages Provided by Certain Embodiments

Embodiments of the invention provide for a group rewards platform where a plurality of users (i.e., consumers registered with the Crowdperks platform) can aggregate their collective demand for products and/or services to obtain certain discounts and/or rewards from the particular sellers with which the plurality of users would like to conduct business and/or form relationships. Thus, embodiments allow users formed as a group to collectively negotiate more favorable discounts and/or rewards than the users could negotiate on their own. At the same time, embodiments allow sellers to create, customize, and enable their own group rewards' programs so that the sellers can meet their business objectives, such as increase sales, increase purchase frequency, improve profit margins, and move expiring inventory.

Loyalty-based programs have existed for some time. However, many prior art loyalty-based programs were administered on an individual basis. As a result, in such prior approaches, the consumer self-determines his or her own spending, and by extension, determines the magnitude and nature of the reward. Once a user is a part of a prior art group program, the user loses some of that self determinism since other users in the group now depend on his spending in order to achieve the group's goals. The group dynamics may affect individual consumer behavior, which may unfortunately result in unequal or disproportionate incentives/rewards for the members of the group.

In contrast, embodiments of the invention provide for an efficient mechanism where consumers and sellers (such as, without limitation a merchant or a service provider) can form unique and customized relationships that benefit both the seller and the individual users of the group. Embodiments enable a novel and efficient approach for group formulation, communication amongst group members, tracking of each user's purchases, and reward issuance.

Table 1 below illustrates illustrative benefits achievable through features of various embodiments. Table 1 is not intended to depict a comprehensive or mandatory list of features; thus, other embodiments of the invention possess different features than those listed in Table 1.

TABLE 1

| Feature | Benefit |
|---|---|
| Self selected group | Consumers may organize based on an |
| formulation | affinity to derive benefit from a seller |
| Customizable group | A seller can create and launch group |
| rewards engine | rewards programs based on multiple |
| | consumers participating |
| Communication method | Allows the two parties to negotiate and |
| between group and | agree on a custom program that benefits |
| seller | both, thereby creating compelling and |
| | relevant programs for constituents |
| Purchase tracking | Seamless record keeping and |
| | classification of purchases between the |
| | two parties. No need to issue and |
| | distribute user-based cards or tokens |
| Seamless reward/ | Efficient and seamless management |
| credit issuance | system of issuing credits and rewards on |
| | behalf of users. No need for users to |
| | carry coupons or vouchers in order to |
| | redeem. No impact on seller's operations |
| | to issue and process rewards and/or |
| | discounts as it is handled in the back-end |
| | by the Crowdperks platform. |
| User classification | Rating method creates a “credit score” |
| system | based on users purchase history. Allows |
| | users to increase profile in order to attain |
| | better rewards. Alternatively, the rating |
| | system will “keep the user honest” based |
| | on his purchase commitments as a part of |
| | a group |
| Open enrollment | Since the strength of the group is a |
| periods | function of its individual members, open |
| | enrollment allows groups to strengthen |
| | their negotiating position with merchants. |
| | Alternatively, it also allows groups to |
| | dismiss non-performing users who |
| | negatively impact the group's |
| | rating/performance. |

### Architecture Overview

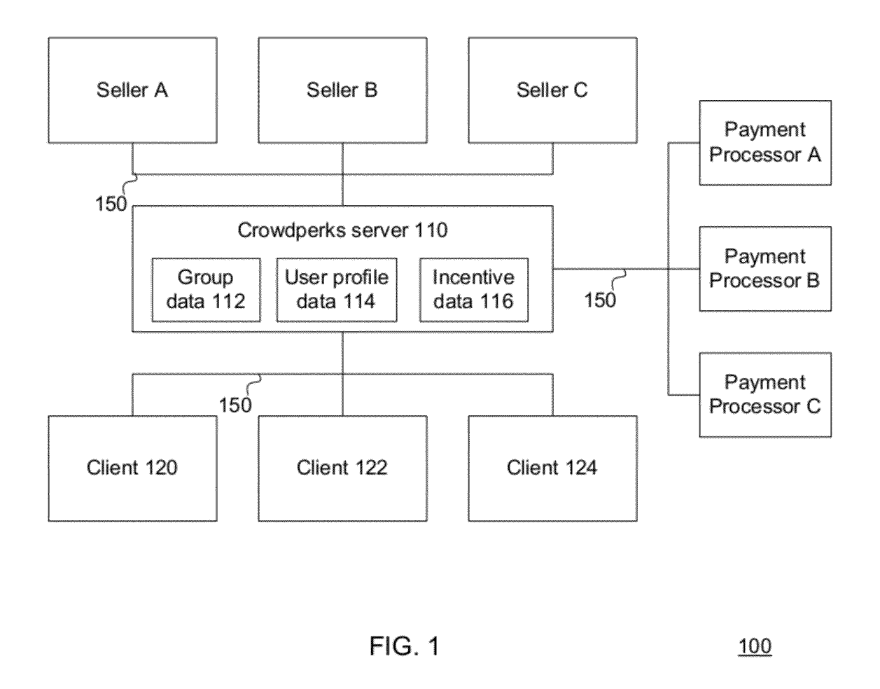

FIG. 1 is a block diagram of an illustrative system 100 according to an embodiment of the invention. In an embodiment, system 100 includes Crowdperks server 110 and clients 120, 122, and 124. Crowdperks server 110, as broadly used herein, is intended to represent one or more servers configured to operate as discussed herein. While Crowdperks server 110 is depicted as being a single entity in FIG. 1 for ease of explanation, those in the art shall appreciate that Crowdperks server 110 may be implemented using a variety of different physical components. To illustrate, in certain embodiments, Crowdperks server 110 may be implemented as a plurality of servers that operate cooperatively, such as in a cluster of servers. Crowdperks server 110 may be implemented as a plurality of servers for performance, scalability, and/or fault tolerant reasons. Additionally, Crowdperks server 110 may represent one or more web servers and one or more application servers which collectively function as a cohesive unit.

In an embodiment, Crowdperks server 110 stores group data 112, user profile data 114, and incentive data 116. Group data 112, as broadly used herein, represents data maintained by Crowdperks server 110 which indentifies and describes all groups, and their members, in system 100. Group data 112 may also identify a variety of other information or characteristics about a group, such as which member or members of the group are acting as a group administrator for the group. Group data 112 is updated by Crowdperks server 110 whenever a group is added, deleted, or changed.

User profile data 114, as broadly used herein, represents data, maintained by Crowdperks server 110, about the users of system 100. For example, user profile data 114 may identify, for each user of system 100, a CP score for the user, which groups the user is a member of, a purchase history for the user, billing information for the user, and name/contact information for the user. User profile data 114 is updated by Crowdperks server 110 whenever information about a user is changed, for example, user profile data 114 may be updated each time a user makes a purchase with a seller registered with system 100.

In an embodiment, user profile data 114 may also identify, for each user registered with system 100, one or more payment instruments for the user. The term payment instrument refers to any type of mechanism for effecting an electronic payment. Non-limiting, illustrative examples of a payment instruments include a credit card, a debit card, a PayPal account, a checking account number, a savings account number, a prepaid account number (gift card), and a deposit account number.

Incentive data 116, as broadly used herein, refers to data, maintained by Crowdperks server 110, which describes and/or defines the terms of a particular rewards program that which negotiated between a group and a seller. Incentive data 116 is updated by Crowdperks server 110 whenever there is any change to a rewards program negotiated between a group and a seller or when such a rewards program is created or expired. Non-limiting, illustrative examples of loyalty rewards programs which may be employed by embodiments are discussed below in the section entitled “Examples of Loyalty Reward Programs.”

FIG. 1 depicts three clients, namely client 120, 122, and 124. The term client refers to any component (typically software being executed by a device) which allows a user to interact with Crowdperks server 110. Non-limiting, illustrative examples of a client include a web page displayed on a PC or a hand-held device (such as a phone, tablet PC, or personal digital assistant), an application executing on a PC or a hand-held device, or any other combination of hardware/software which may be used to communicate with Crowdperks server 110.

While FIG. 1 depicts three clients for purposes of providing a clear example, embodiments of the invention may support any number of clients. Indeed, it is contemplated that embodiments may support a large numbers of clients. A user may use a client to interact with Crowdperks server 110. To illustrate, a user may use client 120 (embodied as an application accessible in a social media web site, such Facebook or Linkedln) to join a group in system 100 or a user may use client 122 (embodied as a web page displayed on a tablet PC) to register with Crowdperks server 110 and/or create a group. Clients may be, but need not be, implemented or displayed on a wide variety of mobile devices.

Clients may interact with Crowdperks server 110 over communications link 150. Communications link 150 is intended to broadly refer to any communications medium capable of enabling digital communication, such as a wireless network, a wired network, the Internet, and a direct physical connection (e.g., a USB port on Crowdperks server 110). As shown in FIG. 1, sellers and payment processors may also electronically communicate with Crowdperks server 110 over communications link 150.

FIG. 1 depicts three sellers, namely sellers A, B, and C. As used herein, the term “seller” represents any provider of a service or product. While only three sellers are depicted in FIG. 1, Crowdperks server 110 may support any number of sellers.

A payment using a payment instrument is ultimately processed by a payment processor. FIG. 1 depicts three payment processors, namely payment processors A, B, and C. While only three payment processors are depicted in FIG. 1, Crowdperks server 110 may support any number of payment processors. Non-limiting, illustrative examples of a payment processor include Bank of America, First Data, Chase Manhattan Bank, and Paymentech. A payment processor may register with Crowdperks server 110. After registering, the payment processor may send payment data that describes business transactions processed by the payment processor to Crowdperks server 110. The payment data received by Crowdperks server 110 identifies the payment instrument used in making purchases. By comparing this data against the list of payment instruments registered with Crowdperks server 110, Crowdperks server 110 may determine which users have made a purchase and with which seller.

Having described various entities and their roles in system 100, how system 100 may be used to create and cultivate incentive-based relationships between a group of consumers and one or more sellers shall now be presented in additional detail.

### Using the Crowdperks Service

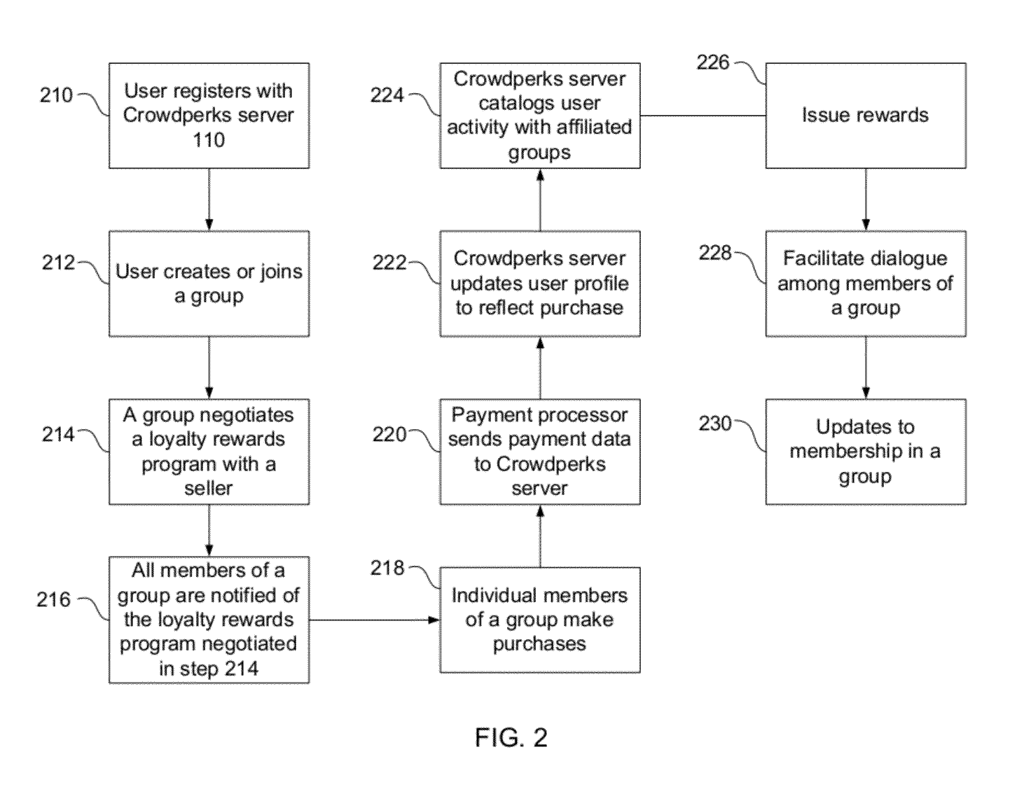

FIG. 2 is a flowchart illustrating the functional steps of an exemplary use case involving an embodiment of the invention. While the steps of FIG. 2 are depicted as occurring in a particular sequence, other embodiments of the invention may perform the steps of FIG. 2 in parallel or in a different order. For example, step 228 may occur anytime throughout the process depicted in FIG. 2 and step 224 may be performed prior to step 222 in certain embodiments.

In step 210, in an embodiment, a user registers with Crowdperks server 110. In an embodiment, a user may initially register with Crowdperks server 110 by providing information about the user, such as name, contact information, and/or billing address, for example. When a user registers with Crowdperks server 110, the user may register one or more payment mechanisms with Crowdperks server 110.

In step 212, a user creates and/or joins a group. In an embodiment, a user of an embodiment may create, join, manage, and/or leave any number of groups. A group is a logical grouping of one or more users. Typically, each user in a group may possess a certain interest, characteristic, or affinity towards a subject. For example, a set of users who are friends or otherwise meet each other through a social network service, such as Facebook or Linkedln, may form a group. As another example, a group of users may be composed of people who have an interest in shopping at a particular store or who like to consume/purchase a particular type of good or service, such as a car wash or brewed coffee. Other examples include a group of users who all reside in the same geographical region, a group of users who all are fans of a similar sports team, a group of users who all are employed by the same employer, and a group of users who all enjoy the same pastime.

It is contemplated that groups may be based on a wide variety of themes, characteristics, or shared interests or traits; however, it is also observed that groups whose shared characteristic or traits may translate into similar purchasing habits may, as shall be explained in further detail below, wield greater negotiating power with a single seller than those groups comprising members having disparate purchasing habits. For this reason, embodiments of the invention may encourage the formation of groups whose members have similar purchasing habits.

When a user creates a group, in an embodiment the creator of the group, by default, becomes the administrator of the group. Administrators of a group may be responsible for managing the membership of the group as well as negotiating with registered sellers. Additional administrators, may, but need not, be added at a later date.

To discover which pre-existing group are available and of interest to join, a user may perform a search using a user interface provided by Crowdperks server 110. For example, a user may perform a key word search on an interest of the user to see related groups which may be joined.

Certain groups may require approval from an administrator of the group for a new user to join. Other groups may be structured so that they are open ended and do not require any approval from an administrator of the group to join.

Certain members of a group may be provided authority to invite other people to join the group. For example, an administrator of the group may have sufficient access privileges to send out invitations to co-workers or friends via email or a social media site (such as Facebook or LinkedIn).

In step 214, a group negotiates a loyalty rewards program with a seller. One approach for performing step 214 is for one or more members acting as administrators of a group to negotiate with a seller that is registered with Crowdperks server 110. A seller may register with Crowdperks server 110 via a user interface exposed by Crowdperks server 110. The negotiations between the administrators of a group and a registered seller may also be conducted using a user interface (denoted the “negotiation user interface”) exposed by Crowdperks server 110. The negotiation user interface may allow both parties to view the current status and history of the negotiation.

In an embodiment, Crowdperks (the business entity managing Crowdperks server 110) may negotiate a loyalty rewards program with a seller for a group instead of the administrator(s) of the group. Such an embodiment may be advantageous if the seller is particularly large or sophisticated. For example, a single administrator user may not wish to, or have the expertise to, negotiate with a large entity such as Walmart or McDonalds.

For example, an administrator of a group may configure the group such that Crowdperks, rather than the administrator(s) of the group, is responsible for performing negotiations between the group and sellers. In this way, Crowdperks may negotiate loyalty rewards programs for a group. In doing so, Crowdperks would attempt to find a balance between the needs/wants of the group and the needs/wants of the seller. Crowdperks may consider the seller's business, general business economics, and what loyalty rewards programs have been successful in the past in the seller's business to develop and negotiate a loyalty rewards program between a group and a seller.

The purpose of the negotiation is to obtain terms, agreeable to both parties, about how to structure the loyalty rewards program. The loyalty rewards program may be structured in a variety of different ways. For example, certain loyalty rewards programs may be based on accumulated spending, whereas others may be based on tier-based spending. In a tier-based structured loyalty rewards program, one or more spending tiers are established. The one or more spending tiers correspond to incremental levels of purchasing activity with the seller. Once a particular spending tier is met or exceeded by a user of a group, then the user is entitled to a particular reward or credit associate with that spending tier. Parties may agree to any amount or type of reward or credit to be associated with a particular spending tier, including but not limited to a percentage of discount to be applied to all future transactions with the seller, a one-time cash back payment from the seller to the user, or the seller pays for the tax on all future transactions with between the user and the seller.

Loyalty rewards programs may be arbitrarily complex and may consider any number of variables. For example, the particular reward/credit available under a loyalty rewards program may depend upon the time of day of the transaction with the seller and/or the particular product or service purchased from the seller. For example, a seller may wish to move more inventory in the morning and so may offer an incentive (via a greater discount) to users of a group to purchase merchandise from the seller during a certain period of time in the morning. As another example, the seller may communicate a deal to members of a group that certain products are on sale and any user who purchases such products is eligible to receive a certain discount.

In addition to the rewards/credits available under the negotiated loyalty rewards program between a seller and a group, the seller may wish to offer members of the group an additional deal for a certain period of time and/or on certain products or services. In this way, a deal may originate with a seller and may be communicated to the members of one or more groups via the Crowdperks system 100. Once Crowdperks server 110 becomes receiving, from a seller, information about a deal the seller wishes to offer, Crowdperks server 110 may communicate the deal to all intended recipients.

Note that while members of the group each share the same loyalty rewards program with a seller, each member of the group may be receiving different levels of rewards/credits under the same loyalty reward program. For example, if user A spends $10,000 with a seller and user B spends $3,000 with a seller, then user A may be entitled to receive 30% off all future purchases with the seller while user B may be only entitled to receive 15% off all future purchases with the seller because user A has met or exceed a milestone (for example, spending $8,000 with the seller) which user B has not.

Once the administrators of a group and a seller have agreed upon terms of a loyalty rewards program, in step 216, all users of the group are notified of the negotiated deal. Such notification may be performed electronically, for example, through a user interface exposed by the Crowdperks server 110. Since Crowdperks server 110 maintains contact information for each user in user profile data 114, Crowdperks server 110 may notify each user of the group using any manner identified in the user profile data 114, e.g., the user may indicate a preference on how he or she would like to be notified, such as by email, social media connections such as Facebook, Twitter, fax, instant message, SMS, or phone call as well as the users affinity group communication portal.

In step 218, users of the group make purchases. Note that users of a group may make purchases at any point in time, and not just after the performance of step 216. Some of the purchases made by registered users of system 100 may be with registered sellers of system 100.

In step 220, a payment processor sends payment data to Crowdperks server 110. Prior to step 220, the payment processor registered with Crowdperks server 110, and so the payment processor has been informed of how to communicate with Crowdperks server 110. A payment processor may periodically (for example, once or twice a day or in real-time based on the level of integration between CP and processors) sent payment data to Crowdperks server 110. The particular frequency at which a particular payment processor sends payment data to Crowdperks server 110 will be agreed upon by both parties.

In an embodiment, payment data include information identifying, for each transaction, the payment instrument and account number used in the transaction, the seller, the amount of the purchase, and the date and time of purchase. In other embodiments, payment data may also include Level 3 information. Level 3 information refers to a type of more detailed information about purchases of a transaction. When a seller and a user each register with system 100, each may grant permission for the seller to send the Level 3 information to Crowdperks server 110. Level 3 information provides greater visibility into what goods/services were purchased by the user.

Upon receiving the payment data from a payment processor, Crowdperks server 110 examines the payment data to identify transactions between registered payment instructions and registered sellers. Note that the payment data received by Crowdperks server 110 may contain data describing users or sellers not registered with Crowdperks server 110, in which case Crowdperks server 110 will ignore these transactions, so long as the data is not useful in strengthening the user/seller relationship or not helpful for Crowdperks to facilitate rewards between the two parties.

In an alternate embodiment, Crowdperks server 110 may contact one or more payment processors to retrieve payment data, thereby avoiding the need for the payment processor to send the payment data to Crowdperks server 110. For example, Crowdperks server 110 may electronically log into a computerized system of a payment processor each night and retrieve the payment data.

In step 222, Crowdperks server 110 updates user profile data 114 to reflect each purchase of a registered user with a registered seller. In step 222, the user profile of each register user who made a purchase with a registered seller is updated to record a certain amount of information about the transaction (the details of what information is recorded/saved about a transaction may be configured by embodiments).

Additionally, in step 222, the CP score of each user may be updated to reflect each new transaction made. As embodiments of the invention may implement the CP score using different approaches, the manner in which the CP score is updated in step 222 may differ across embodiments. For example, if the CP score directly corresponds to the amount of dollars that the user spends, then the CP score may be updated to reflect the new dollar amount which the user has spent. As another example, the individual gradients of a CP score may identify a range of dollars spent by the user (e.g., $300-$500), and so the CP score may only be updated when the user spent enough money to be categorized by a new CP score.

Embodiments of the invention may calculate the CP score in a variety of different ways. According to one approach to calculating a CP score for a user, each user may receive a certain number of points for each purchase the user makes with a registered seller in system 100 and a certain number of points for each purchase the user makes as part of a group. The number of points the user has may be compared to the number of groups the user has joined to obtain the CP score in an embodiment.

A CP score may be expressed as a numerical value and may be displayed next to the user on a screen in association with a symbol and/or a color to provide a quick visual indication of the CP score of the user. In this way, users with a good or bad CP score may be quickly ascertained by viewing the color of the text of the CP score of a symbol displayed in association with the CP score. For example, users that possess a good CP score may be displayed in green and/or with a positive symbol, such as a smiley face, an up arrow, or a star. On the other hand, users that possess a bad CP score may be displayed in red and/or with a negative symbol, such as a frowning face, a down arrow, or a thundercloud.

In step 224, Crowdperks server 110 updates group data 112 to update activities of each member with a particular group. A group score for a group is a measure of all the CP scores of its members. The group score for a group may be calculated in a variety of different ways. For example, the group score for a group may be calculated based on (a) the average CP scope of its members, (b) the medium CP score of its members, (c) the sum of the CP score of its members, or (d) a formula considering two or more factors.

Steps 222 and 224 may be performed at different intervals in different embodiments. For example, certain embodiments may perform steps 222 and 224 each time Crowdperks server 110 receives payment data from a payment processor in step 220. Alternatively, Crowdperks server 110 may perform steps 222 and 224 once a day. In an embodiment, Crowdperks server 110 may perform steps 222 and 224 in real-time as soon as Crowdperks server 110 is notified of a user purchase. In another embodiment, Crowdperks server 110 may be notified of a plurality of user purchases contemporaneously, and Crowdperks server 110 may perform steps 222 and 224 for these groups of purchases as a single batch. The particular interval and/or timing in which steps 222 and 224 are performed by embodiments may be configured by an administrator of system 100.

In step 226, Crowdperks server 110 issues rewards/credit to members of the group. The rewards/credits issued to a user in step 226 will be those in which the user qualifies for based on the loyalty rewards program negotiated in step 214.

Advantageously, as Crowdperks server 110 stores information about at least one payment instrument registered with each user, Crowdperks server 110 is able to issue rewards/credits directly to a payment instrument associated with the user. For example, in an embodiment, Crowdperks server 110 may send credit instructions to a merchant bank associated with the payment instruction for the user to provide a credit/refund to the user. Thus, the user is sparred the inconvenience of taking any express action (such as mailing in a rebate form or logging into a web site) in order to obtain the negotiated rewards/credit he or she is due, since the rewards/credit is automatically applied to the user's payment instrument by Crowdperks server 110.

In step 228, members of a group may engage in dialogue and communicate with each other. Crowdperks server 110 may expose a user interface, such as a web site, to enable users of a group to communicate with each other and monitor activity of the group.

In step 230, a particular group may offer open enrollment or other such recruiting activities. Similarly, in step 230, administrators of a group may terminate members of a group for not meeting certain minimum levels of activity. Terminating such underperforming members may be desirable, as underperforming members may cause a group score to be lower, which in turn may decrease the negotiating power of the group with sellers.

### Time Window for Negotiations

In an embodiment, all negotiations between a group and a seller occur in a bounded period of time, the length of which may be configurable. The purpose of this is to avoid any open ended negotiations. In certain embodiments, sellers and/or groups may specify/configure the period of time in which negotiations are to occur and conclude, although there may be a maximum time period established for certain embodiments which cannot be exceeded, even if desired by one or more of the parties.

In an embodiment, one of more of the group and the seller may configure a certain acceptable range of terms. For example, a group or seller (party A) may indicate a certain range of discounts/rewards which they find acceptable. If the other party (party B) responds with terms that are within the range of terms already indicated as being acceptable, then an agreement on a loyalty rewards program may be established automatically without waiting for party A to manually agree to the terms offered by party B, since party A has previously indicated such terms would be acceptable.

### Examples of Loyalty Rewards Programs

Embodiments of the invention may support a wide variety of loyalty rewards programs. To illustrate, a loyalty rewards program of an embodiment may be based on the time of day of the purchase of the good or service. In such an approach, the purchaser may be given a certain percentage off the purchase price or a certain fixed dollar amount off the purchase price if the purchase of the good or service offered by the seller is made between a certain interval of time (such as 6 PM to 8 PM).

As another example, a loyalty rewards program of an embodiment may be based on the particular day of the purchase of the good or service. In such an approach, the purchaser may be given a certain percentage off the purchase price or a certain fixed dollar amount off the purchase price if the purchase of the good or service offered by the seller is made on a particular day (such as a Thursday) or within a range of days (such as Monday-Wednesday).

Loyalty rewards programs may also use a tier-based spending structure in an embodiment. In a tier-based spending structure, a certain number of spending levels (or “tiers”) are established. For example, the lowest tier may be $25, then $50, then $100, and thereafter increments of $100 up to $500. Each tier is associated with a certain discount or reward. The particular amount of the discount or reward associated with a tier is proportional to the placement of the tier in the sequence of tiers. For example, a user may receive a certain dollar amount off the purchase price or a certain percentage off the purchase price if the total amount spent with the seller for that transaction exceeds the dollar amount associated with the lowest tier ($25 in this example), the user may receive a higher dollar amount off or a higher percentage off the purchase price if the total amount spent with the seller for that transaction exceeds the dollar amount associated with the next highest tier ($50 in this example), and so on. Such an approach provides a larger discount or reward for a higher cost transaction.

In certain embodiments, loyalty rewards programs may employ an accumulated spending structure. In an accumulated spending structure, the amount of the discount or reward offered by a seller for a group is determined based on the total amount of money spent collectively with the seller by members of the group over a certain period of time. Such an approach provides a larger discount or reward for a larger amount of money spent with the seller. For example, an accumulated spending structure may be structured such that for every $10,000 spent with the seller by members of a group, members of the group are offered a slightly higher dollar amount off or percentage off their next purchase with the seller.

Loyalty rewards programs of certain embodiments may employ a sequential spending structure. In a sequential spending structure, the amount of the discount or reward offered by a seller to a member of the group increases with each purchase by the member with the seller. For example, a user may receive a certain dollar amount off or a certain percent off of the total cost of the user's first purchase with the seller. Thereafter, the dollar amount off or the percentage off may be slightly increased with each subsequent purchase with the seller by the user. Such an approach provides a larger discount or reward for repeat business.

Loyalty rewards programs of embodiments of the invention may be as complex or simple as necessary and may include any combination of the above examples of an loyalty rewards program as well as others not expressly discussed above. Certain embodiments may structure a loyalty rewards program using a first approach, and then after an event or milestone switch to a second approach. Thus, embodiments of the invention are not limited to the use of any particular loyalty reward program.

### Illustrative Examples

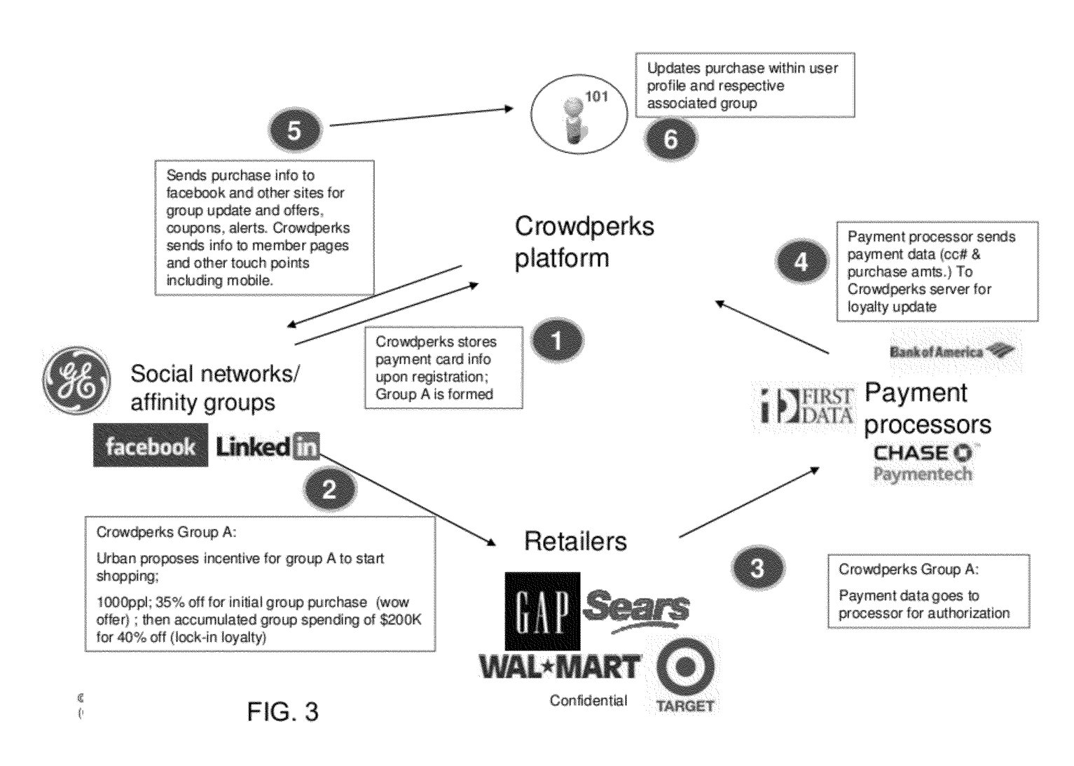

FIG. 3 is a graphical illustration of an exemplary process flow according to an embodiment of the invention. As shown in step 1, Crowdperks server 110 enables a person to register with the Crowdperks service, which includes storing information about a payment instrument for the user. The user subsequently forms Group A.

In step 2, the user invites his friends, co-workers, associates, and other members in his affinity group to join Group A by communicating with them over social networks or other communication platforms. Thereafter, Group A negotiates and establishes loyalty rewards programs with sellers, each of which may need to be negotiated within certain defined periods of time. For example, Urban Outfitters (“Urban”) proposes a loyalty rewards program to Group A in recognition of Group A's size being at least 1000 people. The loyalty rewards program includes 35% off purchases made by members of the group, and 40% off purchases made by the group if the group spends more than $200,000.00 with Urban Outfitters within a defined period of time as agreed upon by Group A and Urban.

In step 3, whenever a user makes a purchase with a payment instrument, information about the transaction is sent from the seller to a payment processor for authorization.

Step 4 illustrates several exemplary payment processors, namely First Data, Bank of America, Chase Manhattan Bank, and Paymentech. In step 4, a payment processor sends payment data (such as a credit card and purchase amount) to Crowdperks server 110. Alternatively, Crowdperks server 110 may request the payment data from a payment processor.

In step 5, Crowdperks server 110 may notify users of the CP score and other information. For example, Crowdperks server 110 may receive, from a seller, information about offers and/or coupons which the seller wants to offer to members of one or more groups. Crowdperks server 110 may also notify users of such offers and/or coupons. Users may be contacted by Crowdperks server 110 in a number of different ways, e.g., via Facebook and similar web sites and/or using any contact information available in a user profile, such as an email address.

In step 6, Crowdperks server 110 updates user profiles associated of users who made transactions with registered sellers. Additionally, Crowdperks server 110 updates the group score of any group whose members made purchases with registered sellers.

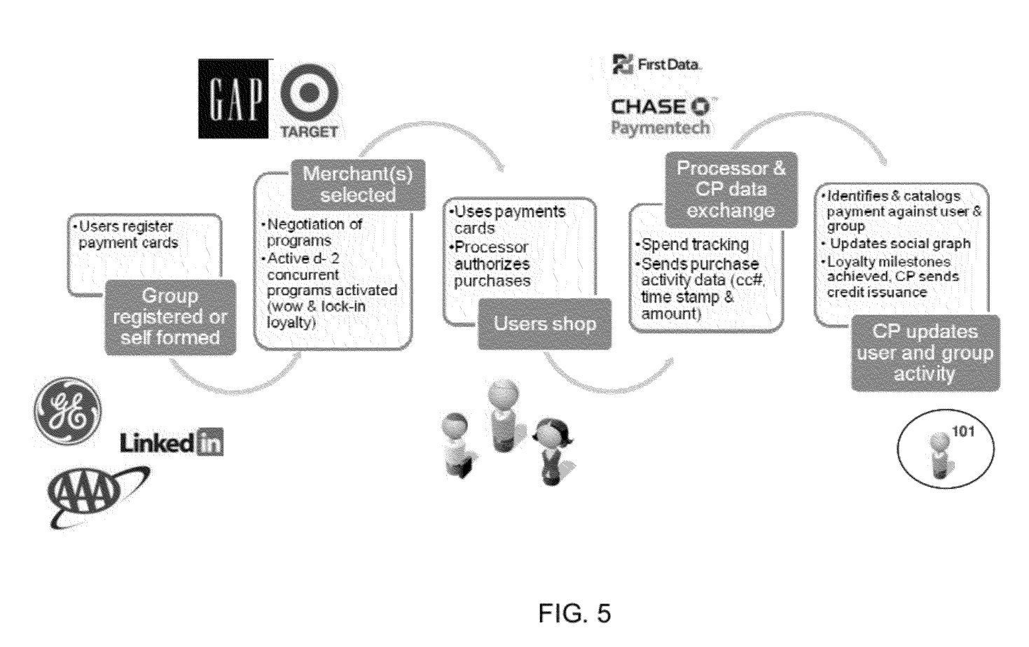

FIG. 5 is another graphical example of the above exemplary process flow according to an embodiment of the invention.

As another example, a group may be formed rather quickly in a manner similar to a flash mob. Consider a hot dog vendor or any food vendor servicing the baseball stadium who wishes to sell a certain number of hot dogs at a baseball stadium. The hot dog vendor may register with Crowdperks server 110. Thereafter, a deal on hot dogs may be communicated to a group of users, e.g., the deal could be communicated via a smart phone application. A user could use a cell phone or other mobile device to contact Crowdperks server 110 to see what businesses that are registered with Crowdperks server 110 are located nearby. In this way, the user could discover the deal from the hot dog vendor. Alternately, the user could try to form a group to obtain a deal with the hot dog vendor. If the hot dog vendor determines that 150 people have joined a group and are interested in obtaining a deal on a hot dog, the hot dog vendor may determine, using his or her business judgment, that a deal on hot dogs should be made and communicated to members of the group. Such a deal may be time sensitive and may expire after a certain amount of time, e.g., 30 minutes after the conclusion of the ball game.

### Group Formation

In an embodiment, there may be a minimum number of people to form a group, e.g., 25 people. Other limits and/or criteria may be established. For example, there may be rules which require a certain percentage of the members of a group to meet certain demographics (such as age or income) for a group to be formed or maintained. Such rules may be advantageous because certain demographics help predict the purchasing habits of a user, e.g., an older person with more disposable income may be more attractive to a certain seller than a person in high school. On the other hand, for other sellers, a younger consumer may be more valuable than an older consumer, depending on the nature of the seller's business.

In an embodiment, there may be rules established for merging one or more smaller groups into a single larger group. Similarly, rules may be established for dividing a single group into two or more smaller groups. Such rules may be based on enforcing certain minimum or maximum characteristics of the purchasing habits of a group.

In certain embodiments, groups may form hierarchal relationships. For example, Group A (which corresponds to an affinity group for a high school) may be a successful group in the Crowdperks system 100. However, Group A may wish to cooperate with Groups B, C, and D (each of which corresponding to other high schools in the area) to negotiate with one or more sellers. In this case, Groups A, B, C, and D may form a parent group E which includes all the members of Groups A, B, C, and D. Loyalty rewards programs negotiated by group E will be available to all members of Groups A, B, C, and D. However, loyalty rewards programs negotiated by each of Groups A, B, C, and D would not be made available to any other group. Such a hierarchical relationship advantageously allows the members of Groups A, B, C, and D to have even greater negotiating power with sellers on certain purchases in which is a common interest to all; however, each of Groups A, B, C, and D may still pursue loyalty rewards programs that are of interest that that group without adversely affecting the other groups that are not interested in such loyalty rewards programs.

### Monetization of the System

In an embodiment, Crowdperks system 100 may receive, from registered sellers for each transaction, a flat fee or a percent of the transaction a registered user makes with the registered seller. The particular fee arrangement may be negotiated between Crowdperks and the seller at the time the seller registers with the Crowdperks system.

### Working with Established Affinity Groups

Crowdperks system 100 may be easily used with established affinity groups, such as, for example, the American Automobile Association (AAA) or a high school. Embodiments of the invention provide a mechanism for such established affinity groups to raise funds and/or provide discounts to their members using a trackable and performance-based rewards system for affinity groups. In an embodiment, an established affinity group may be extended an offer to form a group under Crowdperks system 100. The group for an established affinity may be provided, by Crowdperks, a percentage of the fees collected by Crowdperks from sellers based on transactions involving the group. In this way, the more users of the group spend, the greater the sum of money Crowdperks will provide the affinity group. This provides an easy way for members of the affinity group to raise funds. Alternatively, rather than providing the affinity group a lump sum in payment, Crowdperks may use the money to provide additional discounts to members of the group. Such an approach may be advantageous to the affinity group (such as AAA) as it may reduce turnover in the group's membership due the desirable nature of the discounts.

### Implementing Mechanisms

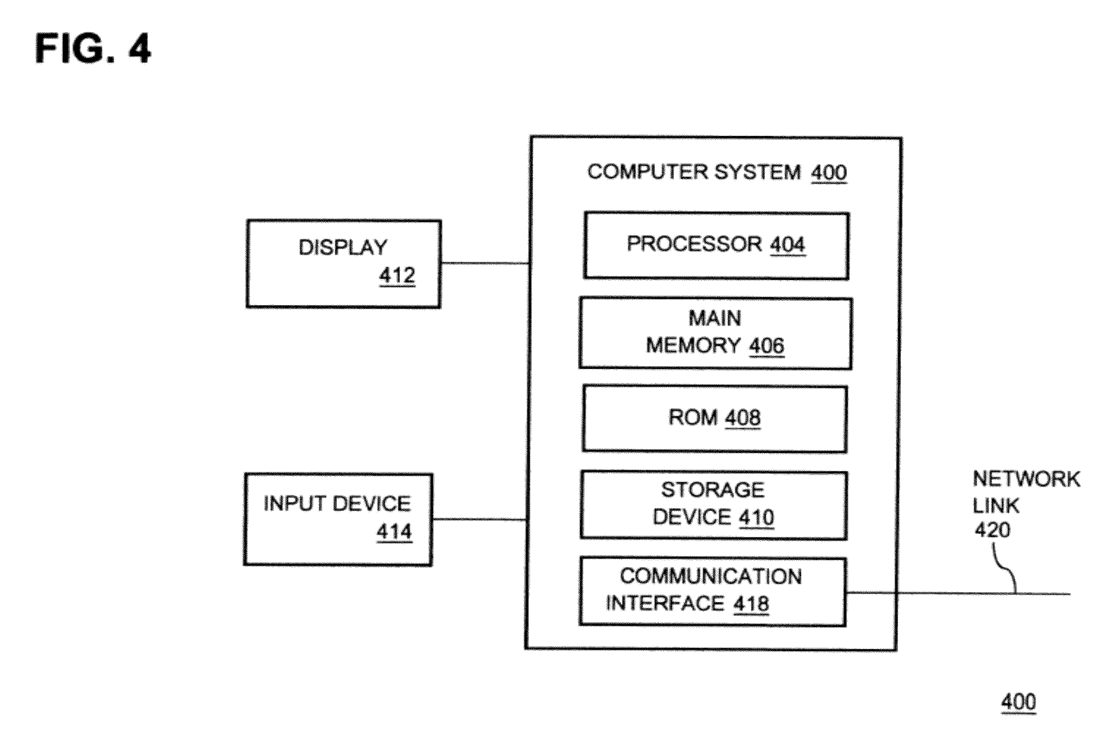

In an embodiment, one or more of Crowdperks server 110 and clients 120, 122, and 124 may be implemented on or using a computer system. FIG. 4 is a block diagram that illustrates a computer system 400 upon which an embodiment of the invention may be implemented.

Embodiments of the invention may be implanted “in-the-cloud” or implementing, in whole or in part, over a network, such as the Internet. For example, clients 120, 122, and 124 may interact with Crowdperks server 110 over a network, such as the Internet. Alternately or additionally, any functional part of a client or a server may be located remotely over a network to other parts of the client or server. For example, a client or server may access data stored remotely over a network and/or may interact with one or more processes executing on a different physical machine.

In an embodiment, computer system 400 includes processor 404, main memory 406, ROM 408, storage device 410, and communication interface 418. Computer system 400 includes at least one processor 404 for processing information. Computer system 400 also includes a main memory 406, such as a random access memory (RAM) or other dynamic storage device, for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device for storing static information and instructions for processor 404. A storage device 410, such as a magnetic disk or optical disk, is provided for storing information and instructions. Storage device 410 may also be implemented using a cloud-based storage system. Thus, storage device 410 need not be physically located in computer system 400, but instead, may be at a location accessible, such as via a network, to computer system 400.

Computer system 400 may be coupled to a display 412, such as a cathode ray tube (CRT), a LCD monitor, and a television set, for displaying information to a user. An input device 414, including alphanumeric and other keys, is coupled to computer system 400 for communicating information and command selections to processor 404. Other non-limiting, illustrative examples of input device 414 include a mouse, a trackball, or cursor direction keys for communicating direction information and command selections to processor 404 and for controlling cursor movement on display 412. While only one input device 414 is depicted in FIG. 4, embodiments of the invention may include any number of input devices 414 coupled to computer system 400.

Embodiments of the invention are related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement embodiments of the invention. Thus, embodiments of the invention are not limited to any specific combination of hardware circuitry and software.

The term “machine-readable storage medium” as used herein refers to any medium that participates in storing instructions which may be provided to processor 404 for execution. Such a medium may take many forms, including but not limited to, non-volatile media and volatile media. Non-volatile media includes, for example, optical or magnetic disks, such as storage device 410. Volatile media includes dynamic memory, such as main memory 406.

Non-limiting, illustrative examples of machine-readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip or cartridge, or any other medium from which a computer can read.

Various forms of machine readable media may be involved in carrying one or more sequences of one or more instructions to processor 404 for execution. For example, the instructions may initially be carried on a magnetic disk of a remote computer. The remote computer can load the instructions into its dynamic memory and send the instructions over a network link 420 to computer system 400.

Communication interface 418 provides a two-way data communication coupling to a network link 420 that is connected to a local network. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through a local network to a host computer or to data equipment operated by an Internet Service Provider (ISP).

Computer system 400 can send messages and receive data, including program code, through the network(s), network link 420 and communication interface 418. For example, a server might transmit a requested code for an application program through the Internet, a local ISP, a local network, subsequently to communication interface 418. The received code may be executed by processor 404 as it is received, and/or stored in storage device 410, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer readable storage medium storing one or more sequences of instructions, which when executed by one or more processors, causes:
storing group data that identifies a group of users that have entered into an agreement to negotiate, as a single entity, with a seller for terms of a loyalty rewards program;
storing incentive data that identifies a negotiated loyalty rewards program between the group and the seller; and
upon receiving payment data from a payment processor associated with a payment instrument of a particular user of the group, determining whether the particular user is entitled to receive a particular reward based upon (a) a purchase of the particular user identified in the payment data and (b) the negotiated loyalty rewards program.

2. The computer readable storage medium of claim 1, wherein execution of the one or more sequences of instructions further causes:
storing user profile data that identifies that the payment instrument is associated with the particular user.

3. The computer readable storage medium of claim 1, wherein execution of the one or more sequences of instructions further causes:
crediting the payment instrument directly with a monetary sum corresponding to the particular reward.

4. The computer readable storage medium of claim 1, wherein the payment instrument is the sole mechanism for tracking the particular user's purchasing habits with the seller.

5. The computer readable storage medium of claim 1, wherein the group of users establishes a minimum level of purchasing activity, and wherein execution of the one or more sequences of instructions further causes:
receiving notification from an administrator of the group that the particular user is no longer a member of the group due to the particular user not meeting the minimum level of purchasing activity for the group.

6. The computer readable storage medium of claim 1, wherein an administrator of the group of users is responsible for negotiating the loyalty rewards program with the seller.

7. The computer readable storage medium of claim 1, wherein a third party, and not an administrator of the group of users, is not responsible for negotiating the terms of the loyalty rewards program for the group with the seller, wherein the third party is not a member of the group of users, and wherein the administrator of the group must agree to the terms to bind the group of users to the terms of the loyalty rewards program.

8. The computer readable storage medium of claim 1, wherein a third party, and not an administrator of the group of users, is not responsible for negotiating terms of the loyalty rewards program for the group with the seller, wherein the third party is not a member of the group of users, and wherein the administrator does not need to agree to the terms negotiated by the third party to bind the group of users to the terms of the loyalty rewards program if the terms of the loyalty rewards program fall within a pre-approved scope previously deemed agreeable by the administrator.

9. The computer readable storage medium of claim 1, wherein each user in the group of users has joined the group as a result of their express request for membership into the group being granted by an administrator of the group.

10. The computer readable storage medium of claim 1, wherein execution of the one or more sequences of instructions further causes:
receiving authorization from an administrator from the group of users to merge the group of users into a second group of users to form a combined group,
wherein the combined group has greater negotiating power with sellers registered with a platform than the group of users previously did prior to the merge.

11. The computer readable storage medium of claim 1, wherein execution of the one or more sequences of instructions further causes:
receiving authorization from an administrator from the group of users to form a child group of users, wherein loyalty reward programs negotiated by the group of users binds said child groups of users, and wherein the loyalty reward programs negotiated by the child group of users do not bind said groups of users.

12. The computer readable storage medium of claim 1, wherein execution of the one or more sequences of instructions further causes:
for each transaction, by a user registered with a platform, identified within the payment data, a provider of the platform receiving a fee for the transaction from the seller associated with the transaction when the seller is also registered with the platform.

13. An apparatus, comprising:
one or more processors; and
one or more computer readable storage mediums storing one or more sequences of instructions, which when executed by the one or more processors, causes:
storing group data that identifies a group of users that have entered into an agreement to negotiate, as a single entity, with a seller for terms of a loyalty rewards program;
storing incentive data that identifies a negotiated loyalty rewards program between the group and the seller; and
upon receiving payment data from a payment processor associated with a payment instrument of a particular user of the group, determining whether the particular user is entitled to receive a particular reward based upon (a) a purchase of the particular user identified in the payment data and (b) the negotiated loyalty rewards program.

14. The apparatus of claim 13, wherein execution of the one or more sequences of instructions further causes:
storing user profile data that identifies that the payment instrument is associated with the particular user.

15. The apparatus of claim 13, wherein execution of the one or more sequences of instructions further causes:
crediting the payment instrument directly with a monetary sum corresponding to the particular reward.

16. The apparatus of claim 13, wherein the payment instrument is the sole mechanism for tracking the particular user's purchasing habits with the seller.

17. The apparatus of claim 13, wherein the group of users establishes a minimum level of purchasing activity, and wherein execution of the one or more sequences of instructions further causes:
receiving notification from an administrator of the group that the particular user is no longer a member of the group due to the particular user not meeting the minimum level of purchasing activity for the group.

18. The apparatus of claim 13, wherein an administrator of the group of users is responsible for negotiating the loyalty rewards program with the seller.

19. The apparatus of claim 13, wherein a third party, and not an administrator of the group of users, is not responsible for negotiating the terms of the loyalty rewards program for the group with the seller, wherein the third party is not a member of the group of users, and wherein the administrator of the group must agree to the terms to bind the group of users to the terms of the loyalty rewards program.

20. The apparatus of claim 13, wherein a third party, and not an administrator of the group of users, is not responsible for negotiating terms of the loyalty rewards program for the group with the seller, wherein the third party is not a member of the group of users, and wherein the administrator does not need to agree to the terms negotiated by the third party to bind the group of users to the terms of the loyalty rewards program if the terms of the loyalty rewards program fall within a pre-approved scope previously deemed agreeable by the administrator.

21. The apparatus of claim 13, wherein each user in the group of users has joined the group as a result of their express request for membership into the group being granted by an administrator of the group.

22. The apparatus of claim 13, wherein execution of the one or more sequences of instructions further causes:
receiving authorization from an administrator from the group of users to merge the group of users into a second group of users to form a combined group,
wherein the combined group has greater negotiating power with sellers registered with a platform than the group of users previously did prior to the merge.

23. The apparatus of claim 13, wherein execution of the one or more sequences of instructions further causes:
receiving authorization from an administrator from the group of users to form a child group of users, wherein loyalty reward programs negotiated by the group of users binds said child group of users, and wherein the loyalty reward programs negotiated by the child group of users do not bind said group of users.

24. The apparatus of claim 13, wherein execution of the one or more sequences of instructions further causes:
for each transaction, by a user registered with a platform, identified within the payment data, a provider of the platform receiving a fee for the transaction from the seller associated with the transaction when the seller is also registered with the platform.

25. A method for a reward based system for multiple consumers organized as a group, causes:
storing group data that identifies a group of users that have entered into an agreement to negotiate, as a single entity, with a seller for terms of a loyalty rewards program;
storing incentive data that identifies a negotiated loyalty rewards program between the group and the seller;
upon receiving payment data from a payment processor associated with a payment instrument of a particular user of the group, determining whether the particular user is entitled to receive a particular reward based upon (a) a purchase of the particular user identified in the payment data and (b) the negotiated loyalty rewards program; and
crediting the payment instrument directly with a monetary sum corresponding to the particular reward.
